(19) United States
(12) Patent Application Publication
(10) Pub. No.: US 2024/0140016 A1
(43) Pub. Date: May 2, 2024

(54) VACUUM FORM TOOLING

(71) Applicant: 3con Anlagenbau GmbH, Ebbs (AT)

(72) Inventor: Hannes AUER, Schwoich (AT)

(21) Appl. No.: 18/494,941

(22) Filed: Oct. 26, 2023

(30) Foreign Application Priority Data
Oct. 26, 2022 (EP) 22 203 930.7

(51) Int. Cl. B29C 51/26; B29C 51/10; B29C 51/14; B29C 51/36

(52) U.S. Cl. CPC B29C 51/262; B29C 51/10; B29C 51/14; B29C 51/36

(57) ABSTRACT

A vacuum form tooling is configured for a press or vacuum lamination system. The vacuum form tooling comprises a negatively pressurized lower mold supporting at least one substrate element to be laminated or to provide at least one molding tool to be molded. The vacuum form tooling further comprises a negatively pressurized upper mold. The vacuum form tooling includes a clamping frame adapted to clamp a film portion to be laminated on the at least one substrate element or to be molded onto the at least one molding tool. Said clamping frame is moveable from a first position to a second position. In the first position, the clamped film portion can be sucked at least partially into the negatively pressurized upper mold. In the second position, the clamped film portion can be sucked for lamination on the at least one substrate element.

### CROSS-REFERENCE TO RELATED APPLICATIONS

This application claims priority to EP 22 203 930.7 filed Oct. 26, 2022, the entire contents of which are hereby incorporated by reference.

### FIELD

This technology relates to a vacuum form tooling for a press lamination system or for a vacuum lamination system, to a press lamination system including said vacuum form tooling, to a clamping frame to be used in the vacuum form tooling and to a vacuum lamination method.

### BACKGROUND

Vacuum lamination is a manufacturing method for lamination of raw carriers based on materials with surface decorations in a wide variety of colors and haptics. The vacuum lamination manufacturing method is commonly used for manufacturing all kind of laminated parts in different fields of industry, including packaging, automobile and the like. Particularly cladding parts can be formed e.g. of vehicle cabins, such as instrument panels, center consoles, seat back panels and/or door trims. Particularly, in vacuum lamination, a carrier (also denoted as substrate) is bonded to a film by means of an adhesive system applied either to the substrate, the film or both.

Further, vacuum forming is known. Vacuum forming is a manufacturing method for forming thermoplastic films to a specific shape in a mold. Therefore, the film is heated to a high-enough temperature that permits the film to be stretched into or onto a mold and cooled to a finished shape. Thereby a molded film part is formed. Depending on the thickness of the molded film, using thin films e.g. disposable cups, containers, lids, trays, blisters, clamshells, and other products for the food, medical, and general retail industries can be formed. Likewise, using thick film, parts as diverse as (or substrates for) vehicle door and dash panels, refrigerator liners, utility vehicle beds and plastic pallets and/or the like can be molded.

Typical films used for vacuum lamination and/or vacuum forming are thermoplastic films having a thickness from 0.1 to 12 mm. Thermoplastic materials include, but are not limited to acrylonitrile butadiene styrene, ABS, high-impact polystyrene, HIPS, polypropylene, PP, polyethylene, PE, polyvinyl chloride, PVC, and thermoplastic olefin, TPO. Further, composite films can be used for vacuum lamination and vacuum forming. The films may allow for the imitation of natural materials such as wood or leather, or for providing other desired haptic and/or optical appearances.

To ensure that the film adheres to the substrate (in vacuum lamination) as tightly as possible, or is properly molded onto a molding tool (in vacuum forming), i.e. substantially free of bubbles and wrinkles, the film is typically heated before or during lamination/forming. Further, in vacuum lamination, as adhesives such as hotmelt adhesives, or reaction hotmelt adhesives may be used, which have to be heated to a certain temperature to obtain ideal adhesion. It is to be understood, that in vacuum lamination other types of adhesives may also be used, such as solvent based adhesives or (water based) dispersion adhesives.

To apply the film on the substrate or a molding tool, respectively, the film is typically arranged in a clamping frame prior to heating. After the subsequent heating step, a tool that supports the substrate/the molding tool and that is arranged underneath the clamping frame and accordingly underneath the heated film is lifted. Due to the lifting movement, the heated film is formed over the substrate/the molding tool, thereby molding itself to the shape of the substrate and/or the molding tool. The molding is supported by a vacuum applied to the tool so that the heated film is sucked onto the tool, respectively on the substrate and/or the molding tool. For this purpose, the tool and respectively the substrate/the molding tool must have the appropriate air permeability, usually achieved by means of correspondingly small holes or pores, to enable the film to be sucked in by means of said vacuum.

As the film is sucked on the substrate/molding tool, it will be stretched dependent on the shape of the substrate/molding tool. This shape-related degree of stretching of the film, typically results in different film thicknesses over the outer shape of the substrate/molding tool. Further, the different degrees of stretching may impact the optical appearance and the haptic of the final work piece, including substrate and film, or the formed film, only. This is oftentimes undesirable.

Further, as the tool is arranged underneath the clamping frame and accordingly underneath the heated film and then lifted, for large work pieces, particularly for work pieces with a large vertical expansion, plenty of space is required underneath the clamping frame. Oftentimes, the vacuum lamination or forming systems cannot be installed on flat surface factory buildings, but must be installed over respective pits allowing the required vertical lifting and lowering of the large tool/substrate.

Thus, there is a need in the art to provide an improved tooling for vacuum lamination that overcomes the aforementioned drawbacks.

### SUMMARY

Example embodiments herein provide a vacuum form tooling for a press lamination system or a vacuum lamination system. The vacuum form tooling can be adapted to be used in conventional press systems such as a hydraulic, mechanic and/or pneumatic press. In a particular example, the press lamination system may be electrically actuated, e.g. by means of a stepper motor, a servo drive, and/or the like. Further, the vacuum form tooling may be adapted to be used in vacuum lamination systems. Those systems may be driven systems or may be manually operated. Accordingly, the vacuum form tooling may be used for serial production, for small series or for prototyping. The vacuum form tooling comprises a lower mold that is adapted to support at least one substrate element to be laminated or to provide at least one molding tool to be molded. Further the lower mold is adapted to be negatively pressurized.

For supporting the at least one substrate element, the lower mold may include a corresponding nest (or multiple nests, depending on the number of substrate elements to be supported). The nest may have recessed and/or protruding portions to securely support and fix the substrate element for lamination. Further, in case of vacuum forming, the at least one molding tool may be fixed to a nest, as the substrate in a vacuum lamination line up, or the at least one molding tool may be integrally formed with the lower mold.

The substrate element may be any kind of work piece, for example a cladding part of a vehicle cabin, such as an instrument panel, a center console, a seat back panel and/or a door trim. Likewise, the shape of the molding tool is not limited and may be used for forming disposable parts, such as cups, containers, lids, trays, blisters, clamshells, and other products, or parts such as vehicle doors, dash panels, refrigerator liners, utility vehicle beds, plastic pallets and/or the like.

The film portion may be a thermoplastic film portion having a thickness from 0.1 to 12 mm, particularly from 0.2 to 10 mm, or from 0.6 to 4 mm. Further, the thermoplastic film may be provided on films or as sheets, which may be cut to desired shape prior to clamping. The film portion may include or may be made of any kind of thermoplastic material, including, but not limited to acrylonitrile butadiene styrene, ABS, high-impact polystyrene, HIPS, polypropylene, PP, polyethylene, PE, polyvinyl chloride, PVC, and thermoplastic olefin, TPO. Further, composite films can be used for vacuum lamination and vacuum forming.

For getting negatively pressurized, the lower mold may include a vacuum suction line, that can be connected to a respective vacuum system, providing a negative pressure/vacuum. The suction line may be in communication with a plurality of suction holes, distributed over the lower mold, so as to provide for a proper sucking of a film portion.

Further, the vacuum form tooling comprises an upper mold. The upper mold is adapted to be negatively pressurized. Accordingly, the upper mold may include a vacuum suction line, that can be connected to a respective vacuum system, providing a negative pressure/vacuum. The suction line may be in communication with a plurality of suction holes, distributed over the upper mold, so as to provide for a proper sucking of a film portion.

Further, the upper mold is arranged movable and can be moved towards the lower mold from an open position to a closed position. In the closed position, the at least one substrate element can be laminated with a respective film portion. For vacuum forming, in the closed position, the film portion can be laminated onto the at least one molding tool. The closed position is therefore also denoted as laminating or molding position.

Additionally, the vacuum form tooling comprises a clamping frame. The clamping frame is adapted to clamp a film portion that shall be laminated on the at least one substrate element supported by the lower mold or that shall be molded onto the at least one molding tool provided by the lower mold. The clamping frame is moveable from a first position to a second position.

In the first position, the clamping frame is positioned relative to the upper mold in a way that the clamped film portion can be sucked at least partially into the negatively pressurized upper mold, particularly in a cavity thereof. To achieve a proper sucking, the clamping frame may sealingly engage with the upper mold when being in its first position. Further, the sealing may be achieved by the film portion that sealingly covers an edge the upper mold. Due to the sealing, the clamped film portion can be effectively sucked at least partially into the negatively pressurized upper mold.

As the film portion is sucked at least partially into the negatively pressurized upper mold, undesired sagging of the film portion—particularly when being heated—can be effectively prevented. Hence, the timing when the film portion comes into contact with the substrate element and/or the lower mold can be controlled.

Further, sucking the film portion at least partially into the negatively pressurized upper mold allows pre-stretching the clamped film portion to that a more uniform film thickness can be achieved on the film laminated support element. This results in an improved surface quality. Still further, a cavity of the upper mold may be shaped and/or pressurized so as to achieve a desired degree of pre-stretching.

In the second position, the clamping frame is positioned relative to the lower mold in a way that the clamped film portion can be sucked for lamination on the at least one substrate element supported by the negatively pressurized lower mold, or for molding onto the at least one molding tool. To achieve a proper sucking of the film portion on the at least one substrate element/molding tool, the clamping frame may sealingly engage with the lower mold when being in its second position. Further, the sealing may be achieved by the film portion that sealingly covers an edge the lower mold. To support the sucking of the clamped film portion on the at least one substrate element/molding tool, the upper mold may be positively pressurized, when being in closed position. Hence, the film portion can be additionally pressed on the at least one substrate element/molding tool.

While the clamping frame is moved from the first to the second position, the upper mold preferably remains negatively pressurized. The negative pressure applied to the upper mold may remain constant or may be varied, so that the film portion can be further sucked into the negatively pressurized upper mold, while the clamping frame moves to the second position.

Particularly, the movement of the clamping frame and the upper mold may be controlled so that the second position and the closed position are reached simultaneously or at least substantially simultaneously. Further, the movement of the clamping frame and the upper mold may be controlled so that the second position is reached prior to the closed position, or vice versa.

As the clamping frame and the upper mold are arranged movable, the form tooling can be installed in a conventional press, such as a servo-press, having a stationary base body. Particularly, the lower mold may be a stationary mold. Hence, the vacuum form tooling and a respective press lamination system or vacuum lamination system can be used in almost any production site. Specific floor structures, such as pits, are usually not required.

Further it has to be noted, that the terms “upper mold” and “lower mold” are not to be understood to define an orientation of the tooling, particularly not a vertical one. However, a vertical orientation of the form tooling may be intended, so that the upper mold is arranged vertically above the lower mold and is moved substantially vertically, when being moved from the open to the closed position. However, any other orientation is possible. For example, a horizontal orientation of the form tooling may be intended, so that the upper mold is arranged nearby the lower mold and is moved substantially horizontally, when being moved from the open to the closed position.

Further, the clamping frame may be configured to be moveable to a third position, wherein the third position is a position arranged outside an interspace formed by the upper mold and the lower mold. This third position can be a position that allows clamping a film portion to the clamping frame, heating a clamped film portion, applying an adhesive on the clamped film portion, and/or the like. It has to be noted, that the clamping frame may be configured to be moveable to at least a forth position, wherein the forth position is a position arranged outside the interspace formed by the upper mold and the lower mold. Hence, the clamping frame can be moved to different stations for treating the clamed film portion (e.g. heating, applying adhesive, . . . ) and/or the clamping frame (e.g. clamping a film portion, removing excess film portions, cleaning, maintenance, . . . ).

Further, the vacuum form tooling may comprise multiple (at least two) clamping frames, which may be moved to the first and second positions and optionally to the third/fourth positions. Thus, for example a first clamping frame may be positioned between the upper and lower mold, so as to laminate/mold a clamped film portion on a respective substrate element/molding tool and a second clamping frame get prepared for a subsequent lamination/molding, e.g. a film portion can be clamped to this second clamping frame.

The vacuum form tooling may further include a heating device. Any suitable heating device, particularly a radiation heating device, such as an IR heating device, may be used. The heating device is adapted to heat the clamped film portion. The heating softens the film and therefore improves the flowability and stretchability of the film portion. The heating device may be controlled so as to heat the film portion to a desired temperature, or may be time-controlled. Further, the heating device may be arranged moveable or may be a stationary heating device.

In case of a movable heating device, the heating device may be moved relative to the clamping frame so as to heat the film portion, when the clamping frame is e.g. in its first or third position. In case of a stationary heating device, the clamping frame may be moved relative to the heating device.

Further, the heating device may be a one-sided heating device, heating the film portion only from one side, or a two sided heating device, sandwiching the film portion to provide heat from two sides.

The clamping frame may be moved from the first to the second position by the upper mold, when the upper mold moves from the open position to the closed position. According to this aspect, the clamping frame may be guided only, i.e. may have no distinct drive. Thus, the movement of the upper mold is transferred to the clamping frame and the clamping frame is moved due to an engagement between the clamping frame and the moving upper mold.

In another aspect, there may be a clamping frame drive, being assigned to the clamping frame. This clamping frame drive is adapted to move the clamping frame from the first to the second and/or third position. Thus, the clamping frame can be moved independently from a movement of the upper mold.

The vacuum form tooling may further include a control unit. This control unit may include software and/or hardware components and may be a stand-alone control unit or may be integrated in a higher-level control unit, such as a control unit of a laminating press or a vacuum lamination system, or the like.

The control unit may be adapted to control the vacuum form tooling to perform the following steps.
move the upper mold to the open position;
apply a negative pressure to the upper mold in order to suck a film portion clamped by the clamping frame at least partially into the negatively pressurized upper mold;
move the upper mold to the closed position and the clamping frame to the second position, and
apply a negative pressure to the lower mold in order to suck a film portion clamped by the clamping frame for lamination on the at least one substrate element supported by the negatively pressurized lower mold, or on the at least one molding tool of the lower mold.

Further, the control unit may be adapted to control the vacuum form tooling to perform the method described in greater detail further below.

The clamping frame may be a three-dimensional clamping frame. Accordingly, when being clamped, the film portion is not arranged in a two-dimensional plane but three dimensionally. Hence, by a three-dimensional clamping frame, the film portion can be pre-formed in accordance with the shape of the substrate element to be laminated or the molding tool to be molded. This increases the surface quality and a more uniform film thickness of the film laminated substrate element/the molded element can be achieved.

Alternatively, or additionally, the clamping frame may include multiple clamping frame elements. At least one clamping frame element may be moveable relative to another clamping frame element. Particularly, the clamping frame element may be translationally moveable and/or rotationally moveable.

The movement of the at least one clamping frame element may be controlled in such a manner, that sagging of the clamped film portion is prevented. Further, by providing moveable clamping frame element(s), the shape of the clamped film portion can be adapted so as to match a shape of the substrate element to be laminated/the molding tool to be molded.

For example, for heating and/or for applying an adhesive, the clamped film portion may be arranged substantially flat in order to provide a uniform heating/adhesive distribution. However, prior to lamination/molding, the clamping frame is readjusted by moving clamping frame element(s) relative to each other and the shape of the clamped film portion can be adapted so as to match a shape of the substrate element/the molding tool. Further, by moving a clamping frame element, stretching of the film portion can be controlled and/or further film can be supplied to the upper/lower mold in order to achieve a more uniform film thickness. Hence surface quality of the work piece can be improved.

The translational movement may be an inward- or outward directed movement and may lead to a tensioning or loosening of the clamped film portion. Likewise, the rotational movement may lead to a tensioning or loosening of the clamped film portion. The rotational movement may be around a longitudinal axis of the respective clamping frame element, and/or around any other axis.

It has to be understood that some of the clamping frame elements may be moved inwardly and others outwardly to control the shape and stretching of the clamped film portion.

The vacuum form tooling may further comprise a cutting device, such as a punching device, for cutting excess film portions after lamination/molding. Further, the cutting device may be arranged moveable or may be a stationary cutting device. In case of a movable cutting device, the cutting device may be moved relative to the film laminated substrate element/molded part so as to cut excess film portions. In case of a stationary cutting device, the film laminated substrate element/molded part may be moved relative to the cutting device.

Further, the clamping frame may be adapted to clamp a film portion, being an exactly cut film portion in a way that no excess film portions are present after lamination/molding. Accordingly, there is no need for a subsequent cutting. The exact cut film portion may be clamped and controlled by a clamping frame, as described above, i.e. a three dimensional clamping frame and/or a clamping frame having at least one movable clamping frame element.

The vacuum form tooling may further comprise an adhesive apply device for applying adhesive on the at least one substrate element and/or the film portion. The applied adhesive may be a reactive adhesive and/or a hotmelt adhesive, and may be applied e.g. by spraying. Accordingly, the adhesive supply device may include at least one nozzle for spraying adhesive on the at least one substrate element and/or the film portion.

The adhesive apply device may be moveable or may be stationary. In case of a stationary adhesive apply device, the film portion and/or the substrate element must be brought to the adhesive apply device. In case of a movable adhesive apply device, the adhesive can be brought to the film portion and/or the substrate element.

Example embodiments further provide a clamping frame for being used in the vacuum form tooling as described above. The clamping frame is adapted to clamp a film portion to be laminated on a substrate element or to be molded onto a molding tool and further comprises a coupling to be coupled to a guide and/or a drive. Accordingly, when in use, the clamping frame can be moved from the first to the second and/or third position.

Further, the clamping frame may be a three-dimensional clamping frame and/or may include multiple clamping frame elements, wherein at least one clamping frame element may be movable relative to another clamping frame element. The movement may be a translational and/or rotational movement, as already outlined above. Accordingly, the advantages set out forth above, can be achieved with this clamping frame.

Example embodiments further provide a press lamination system for vacuum lamination or for vacuum forming. The press lamination system includes at least one vacuum form tooling as described above, and at least one base body for receiving the lower mold and at least one drive for moving the upper mold towards the lower mold from an open position to a closed position. The drive may be a pneumatic drive, a hydraulic drive and/or a mechanic drive. In a particular aspect, the press lamination system may include an electrically actuated press. The electrically actuated press may be electrically actuated, e.g. by means of a stepper motor, a servo drive, and/or the like. Optionally, the press lamination system includes at least one guide, such as a guide rail, for guiding the movement of the clamping frame from the first to the second position.

The press lamination system may further include a conveyor device for automated feeding of substrate elements (to the lower mold) and/or film portions (to the clamping frame), and/or for automated removal of film laminated substrate elements or molded parts. The conveyor device may comprise a conveyor table, e.g. including a conveyor belt and/or a conveying manipulator, such as an industrial robot.

Further, the press lamination system may include a vacuum system for negatively pressurizing the lower mold and/or the upper mold. Particularly, the upper mold and the lower mold may include respective suction lines for being connected to a vacuum system.

Example embodiments further provide a vacuum lamination or vacuum forming method using a press lamination system as described above. The method comprising the following steps, wherein the following order may be varied:
moving an upper mold to its open position;
clamping a film portion in a clamping frame;
optionally, applying adhesive on the film portion and/or the at least one substrate element;
optionally, heating the film portion, using a heating device;
arranging at least one substrate element or a molding tool on the lower mold;
moving the clamping frame to the first position;
applying a negative pressure to the upper mold in order to suck the film portion clamped by the clamping frame at least partially into the negatively pressurized upper mold;
moving the upper mold to the closed position;
moving the clamping frame to the second position;
applying a negative pressure to the lower mold in order to suck the film portion clamped by the clamping frame for lamination on the at least one substrate element supported by the negatively pressurized lower mold, or for molding onto the at least one molding tool of the negatively pressurized lower mold;
laminating the clamped film portion on the at least one substrate element, or molding the clamped film portion onto the at least one molding tool;
moving the upper mold out of the closed position;
optionally, cutting excess film portions using a cutting device from the film laminated substrate element, or the molded film part, and
optionally, removing the film laminated substrate element, or the molded film part from the lower mold.

### BRIEF DESCRIPTION OF THE DRAWINGS

The present disclosure will be more readily appreciated by reference to the following detailed description when being considered in connection with the accompanying drawings in which:

FIG. 1A schematically shows a press lamination system including said vacuum form tooling;

FIG. 1B schematically shows the press lamination system of FIG. 1A, wherein adhesive is applied;

FIG. 1C schematically shows the press lamination system of FIG. 1A, wherein a clamping frame is moved into the system;

FIG. 1D schematically shows the press lamination system of FIG. 1A, wherein a film held by the clamping frame is heated;

FIG. 1E schematically shows the press lamination system of FIG. 1A, wherein an upper tool is set under vacuum;

FIG. 1F schematically shows the press lamination system of FIG. 1A, wherein the upper tool has been lowered to the closed position;

FIG. 1G schematically shows the press lamination system of FIG. 1A, wherein the upper tool has been re-opened;

FIG. 1H schematically shows the press lamination system of FIG. 1A, wherein a cutting device has been inserted;

FIG. 1I schematically shows the press lamination system of FIG. 1A, wherein the vacuum laminated work piece is removed;

FIG. 2A gives a schematic cut view of a three dimensional clamping frame;

FIG. 2B gives a schematic cut view of the three dimensional clamping frame of FIG. 2A, wherein a clamping frame element is moved;

FIG. 2C gives a schematic cut view of the three dimensional clamping frame of FIG. 2A, wherein a clamping frame element is rotated;

FIG. 3A gives a schematic top view of a clamping frame, and

FIG. 3B gives a schematic top view of the clamping frame of FIG. 3A, wherein the clamping frame elements are moved.

### DETAILED DESCRIPTION OF EXAMPLE NON-LIMITING EMBODIMENTS

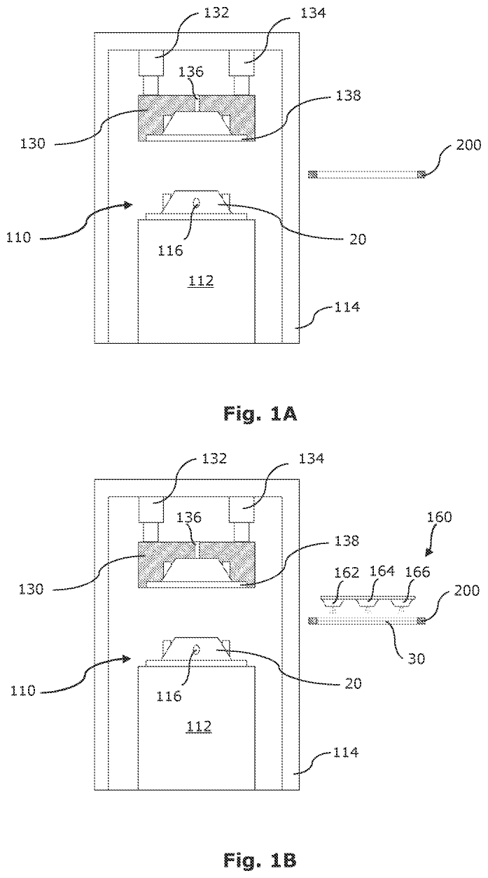

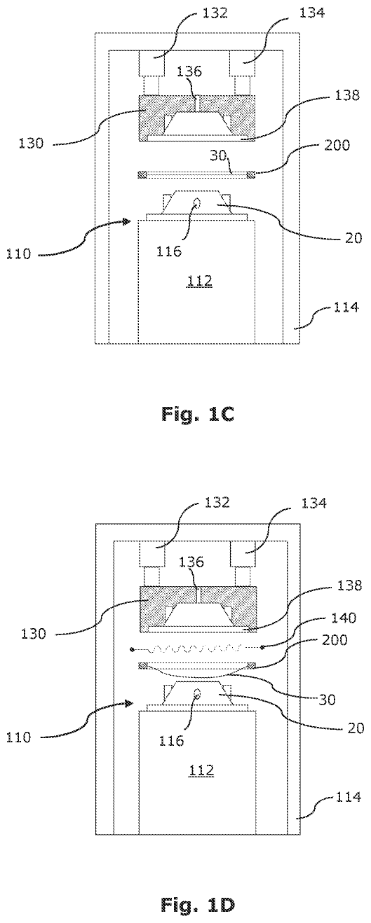

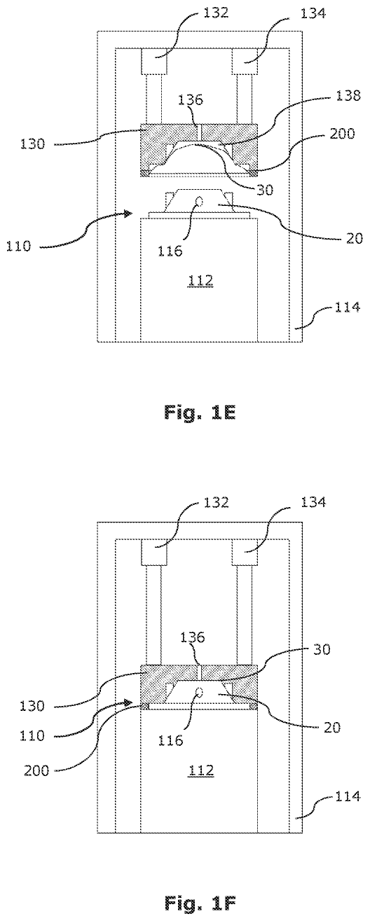

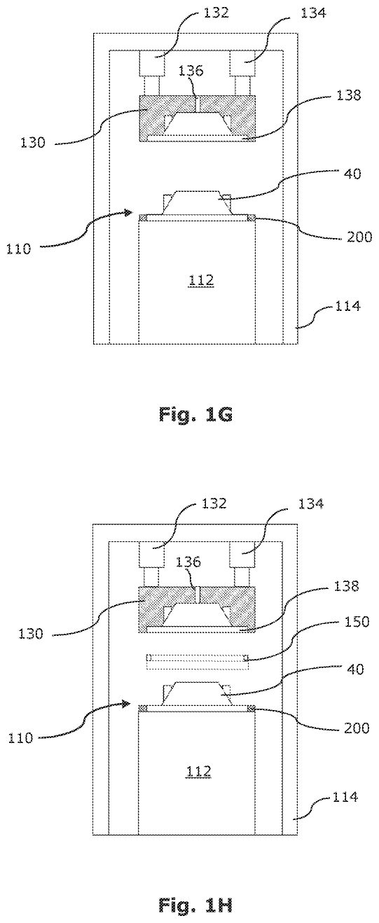

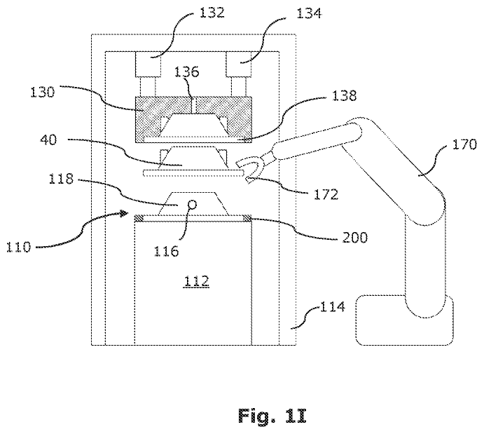

FIGS. 1A to 1I show a press lamination system 1 including a vacuum form tooling 10, while performing different method steps of a vacuum lamination method. It is to be understood, that these method steps can be performed, mutatis mutandis for vacuum forming. For vacuum forming generally no adhesive has to be applied and the substrate element 20 needs to be replaced by a respective molding tool.

Particularly, FIG. 1A shows a press lamination system 1 including a vacuum form tooling 10. The press lamination system 1 includes a stationary base body 112 that receives and supports a lower mold 110 of the vacuum form tooling 10. Further, the press lamination system 1 includes at least one drive 132, 134 for moving an upper mold 130 of the vacuum form tooling 10 towards the lower mold 110 from an open position (cf. FIG. 1A) to a closed position (cf. FIG. 1F). The drives may be arranged on a portal 114, spanning the stationary base body 112,

The press lamination system 1 further comprises a vacuum system (not shown for negatively pressurizing the lower mold 110 and upper mold 130.

The vacuum form tooling 10 comprises a lower mold 110 being a stationary mold in the embodiment depicted in FIG. 1A. It is to be understood, that the lower mold could be arranged movable as well. The lower mold 110 supports a substrate element 20 to be laminated. In particular, the substrate element 20 is held by a nest 118 shown in FIG. 1I. Said lower mold is adapted to be negatively pressurized by means of the vacuum system, which can be in communication with suction line 116. The substrate element is air permeable (at least to a certain degree), so that the vacuum applied to the lower mold can reach the film portion 30 (cf. FIG. 1F).

The vacuum form tooling 10 comprises also an upper mold 130, being adapted to be negatively pressurized by said vacuum system. The vacuum system may be in communication with suction line 136 provided in a cavity 138 of the upper mold 130. As shown in FIGS. 1A, 1F and 1G, the upper mold 130 can be moved towards the lower mold 110 from an open position to a closed position, and vice versa.

Further, the vacuum form tooling 10 comprises at least one clamping frame 200. The clamping frame 200 is adapted to clamp a film portion 30 to be laminated on the at least one substrate element 20. As shown in FIG. 1A, the clamping frame 200 is arranged in a third position, i.e. a position outside an interspace formed by the upper mold 130 and the lower mold 110. In this position, the clamping frame 200 is easily accessible and a film portion can be clamped (cf. FIG. 1B).

As shown in FIG. 1B, the vacuum form tooling 10 optionally includes an adhesive apply device 160 for applying adhesive on the at least one substrate element 20 and/or the film portion 30. The adhesive may be applied by spraying. Accordingly, the adhesive supply device 160 may include at least one nozzle 162, 164, 166 for spraying adhesive on the at least one substrate element 20 and/or the film portion 30. In FIG. 1B, the adhesive is sprayed on the clamped film portion, while the clamping frame being in its third position.

In FIG. 1C, the clamping frame 200 has been moved in an interspace defined by the upper mold 130 and the lower mold 110. The position shown corresponds to the first position of the clamping frame.

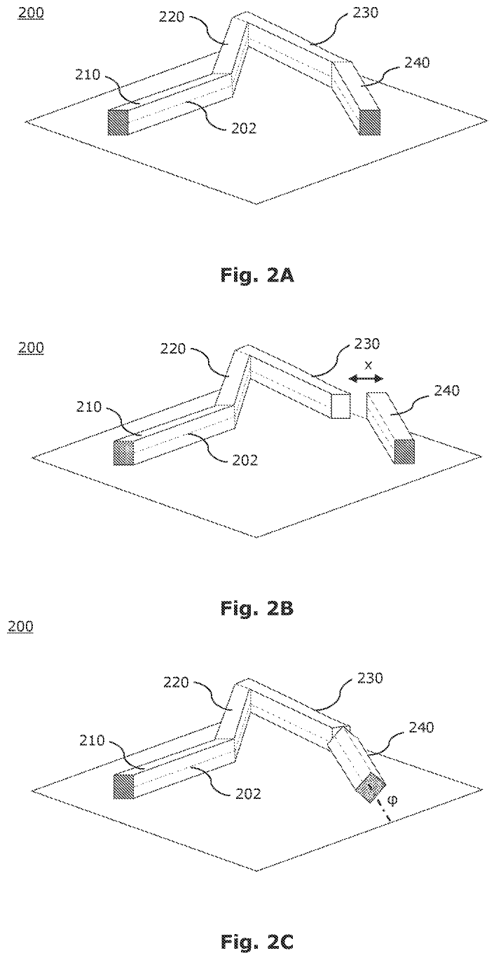

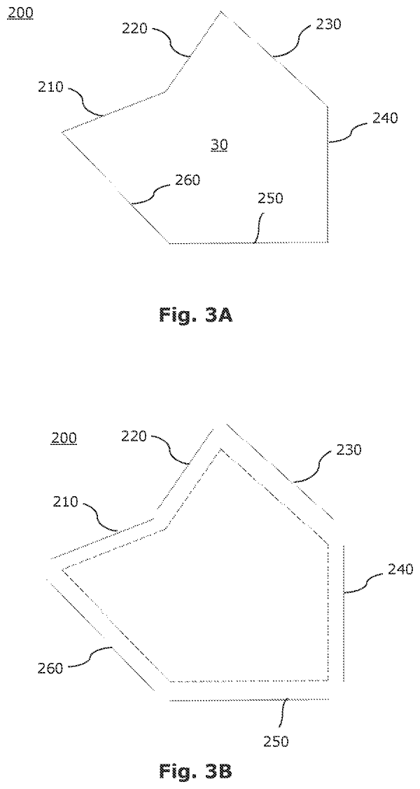

As further shown in FIG. 1D, a heating device 140 may be provided for heating the clamped film portion 30. This leads to a softening and a certain sagging of the film portion. The sagging can be prevented by providing a clamping frame having movable frame elements, as e.g. depicted in FIGS. 2A to 3B. Here, the heating device 140 is a movable heating device, that can be inserted in the interspace defined by the upper mold 130 and the lower mold 110 in order to heat the clamped foil portion from above.

In FIG. 1E, the upper mold 130 is lowered so as to sealingly engage with the clamping frame 200. Subsequently, the upper mold 130 can be negatively pressurized, i.e. a vacuum can be applied to suction line 136 and the cavity 138 is evacuated. As a result, the clamped film portion 30 is at least partially sucked into the negatively pressurized upper mold 130.

As shown in FIG. 1F, the upper mold 130 is further lowered to the closed position and the clamping frame 200 is moved to its second position. In this position, the clamping frame 200 (or the upper mold 130) seals with the lower mold 110. Thus, the clamped film portion 30 can be sucked for lamination on the at least one substrate element 20 supported by the negatively pressurized lower mold 110. This can be supported by positively pressurizing the upper mold. Thereby, the clamped film portion 30 is laminated on the substrate element 20.

After lamination, the upper mold 130 can be moved out of the closed position, i.e. opened again. The film laminated substrate element 40 is still provided on the lower mold 110.

In an optional step, depicted in FIG. 1H, a cutting device 150 (e.g. a punching device) can be provided to cut excess film portions from the film laminated substrate element 40. In case exact cut film portions are used for clamping, this step may be superfluous.

As shown in FIG. 1I the press lamination system 1 may include a conveyor device 170, such as an industrial robot having a gripper 172, or a conveyor table for automated feeding of substrate elements 20 to the lower mold and/or film portions 30 to respective clamping frames 200. Further, the conveyor device 170 may serve for automated removal of film laminated substrate elements 40, as shown in FIG. 1I.

FIG. 2A gives a schematic cut view of a three dimensional clamping frame 200. The film portion (not shown) is clamed along the clamping area 202 illustrated by a dashed line. As seen, the clamped film portion is not arranged in a two-dimensional plane but three dimensionally.

Further, the three dimensional clamping frame 200 includes multiple clamping frame elements 210, 220, 230, 240, that built up the clamping frame 200.

As best seen in FIGS. 2B and 2C, at least one clamping frame element, here clamping frame element 240 may be moveable relative to another clamping frame element, here clamping frame elements 210, 220 and 230. Particularly, the clamping frame element may be translationally moveable and/or rotationally moveable.

As illustrated in FIG. 2B, the translational movement x of clamping frame element 240 may be an outward directed movement and may lead to a tensioning of the clamped film portion. Likewise, the translational movement may be inwardly directed and my lead to a loosening of the clamped film portion.

Further, as illustrated in FIG. 2C, the moveable clamping frame element 240 may be rotated. Here, an outward rotation around a longitudinal axis φ is shown. This rotational movement will also lead to a tensioning of the clamped film portion. Likewise, the rotational movement may be inwardly directed and my lead to a loosening of the clamped film portion. Further, the axis of rotation may be chosen differently. For example, the clamping frame elements 210, 220, 230, 240 may be hinged and may allow for a deformation of the clamping frame, defined by the respective hinges.

FIGS. 3A and 3B give a schematic top view of a clamping frame 200. In FIG. 2A, the clamping frame elements 210, 220, 230, 240, 250, 260 are in their initial position and the clamped foil portion 30 is not (yet) pre-stretched. In FIG. 3B, the clamping frame elements 210, 220, 230, 240, 250, 260 have been moved outwardly, thereby tensioning and pre-stretching the clamped foil portion 30. In FIG. 3B, the initial position of the clamping frame elements 210, 220, 230, 240, 250, 260 is given in dashed lines.

With the clamping frames depicted in FIGS. 2A to 3B, the movement of the at least one clamping frame element may be controlled in such a manner, that sagging of the clamped film portion 30 is prevented. Further, by providing moveable clamping frame element(s), the shape of the clamped film portion can be adapted so as to match a shape of the substrate element to be laminated.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein. The present embodiments are to be considered in all respects as illustrative and not restrictive, and all changes coming within the meaning and equivalency range of the appended claims are intended to be embraced therein.

### LIST OF REFERENCE NUMERALS

1 press lamination system
10 vacuum form tooling
20 substrate element
30 film portion
40 film laminated substrate element
110 lower mold
112 base body
114 portal
116 suction line
118 nest
130 upper mold
132 drive
134 drive
136 suction line
138 cavity of upper mold
140 heating device
150 cutting device
160 adhesive apply device
162 nozzle
164 nozzle
166 nozzle
170 conveyor device
172 gripper
200 clamping frame
202 clamping area
210 clamping frame element
220 clamping frame element
230 clamping frame element
240 clamping frame element
260 clamping frame element
250 clamping frame element
φ rotation
X translation

1. A vacuum form tooling particularly for a press lamination system or for a vacuum lamination system, the vacuum form tooling comprising:
a lower mold, being adapted to be negatively pressurized, wherein the lower mold is adapted to support at least one substrate element to be laminated or to provide at least one molding tool to be molded and;
an upper mold, being adapted to be negatively pressurized, wherein the upper mold can be moved towards the lower mold from an open position to a closed position, wherein in the closed position, the at least one substrate element can be laminated, or the at least one molding tool can be molded; and
a clamping frame, being adapted to clamp a film portion to be laminated on the at least one substrate element or to be molded onto the at least one molding tool, the clamping frame being moveable from a first position to a second position, wherein
in the first position, the clamping frame is positioned relative to the upper mold in a way that the clamped film portion can be sucked at least partially into the negatively pressurized upper mold, and wherein
in the second position, the clamping frame is positioned relative to the lower mold in a way that the clamped film portion can be sucked for lamination or molding on the at least one substrate element, or molding tool, respectively of the negatively pressurized lower mold.

2. The vacuum form tooling according to claim 1, wherein the lower mold is a stationary mold.

3. The vacuum form tooling according to claim 1, wherein the clamping frame, is configured to be moveable to a third position, wherein the third position is a position arranged outside an interspace formed by the upper mold and the lower mold.

4. The vacuum form tooling according to claim 1, further including a heating device, the heating device being adapted to heat the clamped film portion.

5. The vacuum form tooling according to claim 1, wherein the clamping frame is configured to be moved from the first to the second position by the upper mold, when the upper mold moves from the open position to the closed position.

6. The vacuum form tooling according to claim 1, further including a clamping frame drive, being assigned to the clamping frame, wherein the clamping frame drive is adapted to move the clamping frame from the first to the second and/or third position.

7. The vacuum form tooling according to claim 1, further comprising a controller configured to control the tooling to perform operations comprising:
move the upper mold to the open position;
apply a negative pressure to the upper mold in order to suck a film portion clamped by the clamping frame at least partially into the negatively pressurized upper mold;
move the upper mold to the closed position and the clamping frame to the second position;
apply a negative pressure to the lower mold in order to suck a film portion clamped by the clamping frame for lamination or molding on the at least one substrate element, or molding tool, respectively of the negatively pressurized lower mold.

8. The vacuum form tooling according to claim 1, wherein
the clamping frame is a three-dimensional clamping frame, and/or wherein
the clamping frame includes multiple clamping frame elements, wherein at least one clamping frame element is movable relative to another clamping frame element, wherein the movement may be a translational and/or rotational movement.

9. The vacuum form tooling according to claim 1, wherein
the vacuum form tooling further comprises a cutting device, such as a punching device, for cutting excess film portions after lamination, or wherein the clamping frame is adapted to clamp a film portion, being an exactly cut film portion in a way that no excess film portions are present after lamination.

10. The vacuum form tooling according to claim 1, further comprising
an adhesive apply device, for applying adhesive on the at least one substrate element and/or the film portion, wherein
the adhesive supply device may include at least one nozzle for spraying adhesive on the at least one substrate element and/or the film portion.

11. A clamping frame for being used in the vacuum form tooling according to claim 1, the clamping frame
being adapted to clamp a film portion to be laminated on a substrate element or to be molded on a molding tool, the clamping frame further comprising
a coupling to be coupled to a guide and/or a drive, wherein the clamping frame may be a three-dimensional clamping frame and/or may
include multiple clamping frame elements, wherein at least one clamping frame element is movable relative to another clamping frame element, wherein the movement may be a translational and/or rotational movement.

12. A press lamination system for vacuum lamination or for vacuum forming, the press lamination system including
at least one vacuum form tooling comprising:
a lower mold, being adapted to be negatively pressurized, wherein the lower mold is adapted to support at least one substrate element to be laminated or to provide at least one molding tool to be molded and;
an upper mold, being adapted to be negatively pressurized, wherein the upper mold can be moved towards the lower mold from an open position to a closed position, wherein in the closed position, the at least one substrate element can be laminated, or the at least one molding tool can be molded; and
a clamping frame, being adapted to clamp a film portion to be laminated on the at least one substrate element or to be molded onto the at least one molding tool, the clamping frame being moveable from a first position to a second position, wherein in the first position, the clamping frame is positioned relative to the upper mold in a way that the clamped film portion can be sucked at least partially into the negatively pressurized upper mold, and wherein in the second position, the clamping frame is positioned relative to the lower mold in a way that the clamped film portion can be sucked for lamination or molding on the at least one substrate element, or molding tool, respectively of the negatively pressurized lower mold;
at least one base body for receiving the lower mold; and
at least one drive for moving the upper mold towards the lower mold from an open position to a closed position.

13. The press lamination system according to claim 12, further comprising a conveyor device for automated feeding of substrate elements and/or film portions, and/or
for automated removal of film laminated substrate elements.

14. The press lamination system according to claim 12, the system further comprising a vacuum system for negatively pressurizing the lower mold and the upper mold.

15. A vacuum lamination or forming method using a press lamination system of the type comprising
at least one vacuum form tooling comprising:
a lower mold, being adapted to be negatively pressurized, wherein the lower mold is adapted to support at least one substrate element to be laminated or to provide at least one molding tool to be molded and;
an upper mold, being adapted to be negatively pressurized, wherein the upper mold can be moved towards the lower mold from an open position to a closed position, wherein in the closed position, the at least one substrate element can be laminated, or the at least one molding tool can be molded; and
a clamping frame, being adapted to clamp a film portion to be laminated on the at least one substrate element or to be molded onto the at least one molding tool, the clamping frame being moveable from a first position to a second position, wherein in the first position, the clamping frame is positioned relative to the upper mold in a way that the clamped film portion can be sucked at least partially into the negatively pressurized upper mold, and wherein in the second position, the clamping frame is positioned relative to the lower mold in a way that the clamped film portion can be sucked for lamination or molding on the at least one substrate element, or molding tool, respectively of the negatively pressurized lower mold;
at least one base body for receiving the lower mold; and
at least one drive for moving the upper mold towards the lower mold from an open position to a closed position,
the method comprising:
moving an upper mold to its open position;
clamping a film portion in a clamping frame;
optionally, applying adhesive on the film portion and/or the at least one substrate element;
optionally, heating the film portion, using a heating device;
arranging at least one substrate element or a molding tool on the lower mold;
moving the clamping frame to the first position;
applying a negative pressure to the upper mold in order to suck the film portion clamped by the clamping frame at least partially into the negatively pressurized upper mold;
moving the upper mold to the closed position;
moving the clamping frame to the second position;
applying a negative pressure to the lower mold in order to suck the film portion clamped by the clamping frame for lamination on the at least one substrate element supported by the negatively pressurized lower mold, or for molding onto the at least one molding tool of the negatively pressurized lower mold;
laminating the clamped film portion on the at least one substrate element, or molding the clamped film portion onto the at least one molding tool;
moving the upper mold out of the closed position.

16. The method of claim 15 further including cutting excess film portions using a cutting device from the film laminated substrate element, or the molded film part.

17. The method of claim 15 further including removing the film laminated substrate element or the molded film part from the lower mold.

18. The vacuum form tooling according to claim 4, further including an IR heating device being adapted to heat the clamped film portion.

19. A press lamination system according to claim 12 further comprising at least one guide for guiding the movement of the clamping frame from the first to the second position.
